(19) United States
(12) Patent Application Publication
(10) Pub. No.: US 2006/0227285 A1
(43) Pub. Date: Oct. 12, 2006

(54) Diving mask

(76) Inventor: Shao-Yin Huang, Taipei (TW)

Correspondence Address: RABIN & Berdo, PC, 1101 14TH STREET, NW, SUITE 500, WASHINGTON, DC, 20005, US

(21) Appl. No.: 11/299,909

(22) Filed: Dec. 13, 2005

(30) Foreign Application Priority Data
Apr. 8, 2005 (TW) 94205499

(51) Int. Cl. G02C 1/00

(52) U.S. Cl. 351/43

(57) ABSTRACT

A diving mask includes a mask assembly, a strap and at least one lens. Two end of the strap is connected to two edges of the mask assembly to be worn on a user's head. The lens is wedged in the mask assembly. The lens has at least one lateral side being bent to form a smooth curve surface which is extended to the rear side of the user's left and right eyes to provide a wider field of vision. Since the surface of the lens is smooth curve, the visual obstacle and image distortion is eliminated.

### CROSS-REFERENCE TO RELATED APPLICATIONS

This non-provisional application claims priority under 35 U.S.C. §119(a) on Patent Application No(s). 94205499 filed in Taiwan, R.O.C. on Apr. 8, 2005, the entire contents of which are hereby incorporated by reference.

### BACKGROUND OF THE INVENTION

1. Field of Invention

The invention relates to diving mask and particularly to diving mask having one curved lens or two lenses with a unitary radius of curvature extended to the rear side of the user's eyes.

2. Related Art

The field-of-view is the ability to recognize the existence of an object and discern its shape. The field-of-view means what a man can see simultaneously as he stares at an object in front of him. The field-of-view is provided by the visual cells surround the fovea of a retina, and generally referred to as peripheral vision.

When people perform underwater activities, they usually wear diving mask to protect the eyes from being irritated by water and to see the surrounding environment underwater more clearly. Categorized by functions, the diving mask can be divided into swimming goggles used in general swimming and diving mask used while scuba diving or skin diving in the sea. FIG. 1 illustrates swimming goggles 100 commonly used in swimming pools. They have smaller lenses and a limited field-of-view. FIG. 2 and FIG.3 show a diving mask 200 used in the sea. They have greater lenses. A swimmer in a swimming pool generally follows a straight line. To facilitate wearing and removing, and reduce water resistance, swimming goggles 100 are generally made in a smaller size. On the other hand, the diving mask 200 have to focus on water-tight capability and providing a large field-of-view to meet the requirements of free movements in the sea to do all kinds of activities.

In the prior arts, many proposals have been provided regarding assembling and coupling of the lenses and mask, or coupling of the front main lens and the side lens. Not many changes occur to the main structure and features. As shown in FIG. 2, diving goggles 200 mainly have main lenses 210 on the front side and side lenses 220 on lateral sides, which are independent elements. They are bonded or latched together through a special flange structure and a pliable leakage-proof pad. In the actual product, there is a bending corner 230 on the juncture of the side lens 220 and the front main lens 210. Such a structure creates a visual obstacle for the user. This is a shortcoming of the conventional products now on the market that remains to be resolved.

Many types of diving masks having a curved lens also have the problem in image distortion or visual obstacle through the corners or the curved portion. For example, U.S. Pat. No. 5,564,132 and U.S. Pat. No. 6,560,788 provide diving masks with an elongate curve lenses having two rearward formed lateral side. The lenses of U.S. Pat. No. 5,564,132 and U.S. Pat. No. 6,560,788 are partially curved on the lateral portion while the front portion is planar. The field-of-view is widened, but the image through the curved portion is distorted.

To eliminate the image distortion, the other diving masks overcome the problem by spherically-shaped lens and use corrective lenses in addition to improve viewing underwater, such as U.S. Pat. No. 3,899,244, U.S. Pat. No. 3,672,750, U.S. Pat. No. 5,625;425, and U.S. Pat. No. 6,612,693. These types of diving masks are not convenient because an optometry process has to be applied to every individual user for selecting suitable corrective lenses.

U.S. Pat. No. 5,915,541 provides another approach to eliminate the image distortion or visual obstacle. U.S. Pat. No. 5,915,541 has one or two curved-lens system having a progressive corner less curvature with variable radius. But the optimal curvature of the lens is hard to be determined. And also, this type of lens having a progressive corner less curvature with variable radius is not easy to be fabricated.

### SUMMARY OF THE INVENTION

The object of the invention is to provide a diving mask that has a lens formed to a smooth curve surface to eliminate the visual obstacle and image distortion.

The diving mask according to the invention includes a mask assembly, a strap and at least one lens. The strap is connected to the mask assembly to be worn on a user's head to retain the diving mask. The lens is wedged in the mask assembly having a unitary radius of curvature to form a smooth curve surface with a unitary radius of curvature. The lens is extended to the rear side of user's eyes to provide a visual angle greater than 110 degrees.

According to the invention, the lens is form with a smooth curve surface and the bending angles or corners on two sides of the conventional diving mask do not exist. Hence the problem of visual obstacle and image distortion are eliminated. Moreover, the lens is extended in a curved fashion to the rear side of the eyes and can provide a larger field-of-view for the user.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a schematic view of conventional swimming goggles.

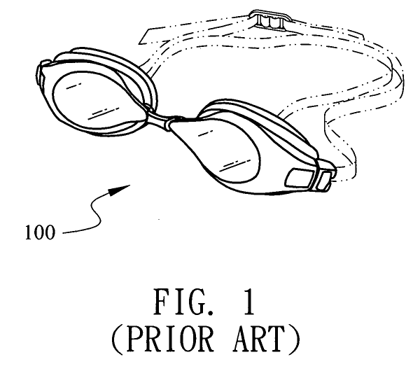

FIG. 2 is a schematic view of a conventional diving mask.

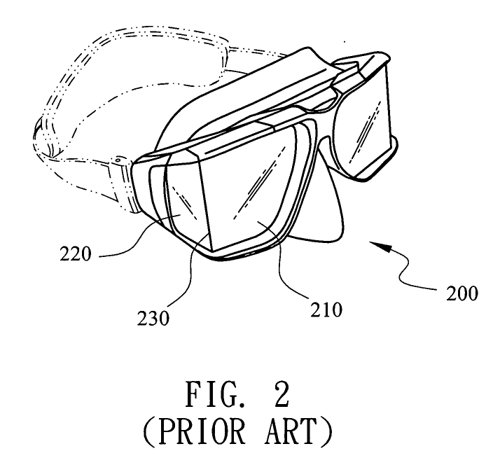

FIG. 3 is a schematic view of a conventional diving mask showing the main lenses and side lenses.

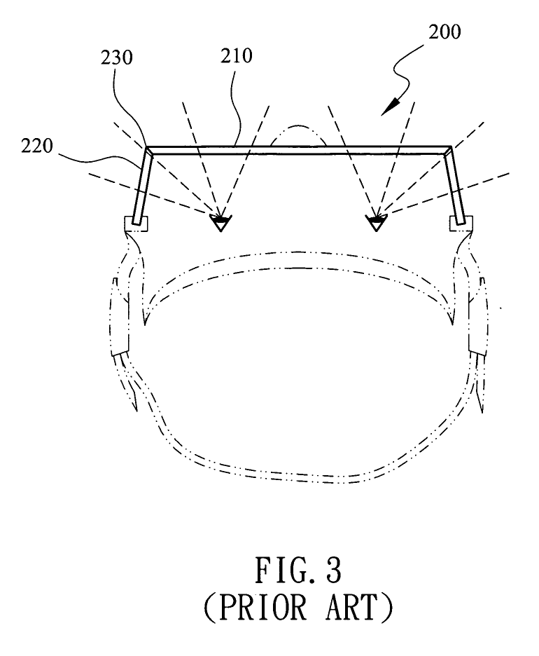

FIG. 4 is an exploded view of the diving mask of the invention.

FIG. 5 is a schematic view of a first embodiment of the diving mask of the invention.

FIG. 6 is an exploded view of a third embodiment of the diving mask of the invention.

FIG. 7 is a schematic view of a second embodiment of the diving mask of the invention.

FIG. 8 is a schematic view of the lens of the third embodiment of the diving mask of the invention.

FIG. 9 is an exploded view of a fourth embodiment of the diving mask of the invention.

FIG. 10 is a schematic view of the lens of the fourth embodiment of the diving mask of the invention.

### DETAILED DESCRIPTION OF THE INVENTION

The diving mask according to the invention are adaptable, but not limited to, diving mask used in the sea or swimming goggles used in a swimming pool.

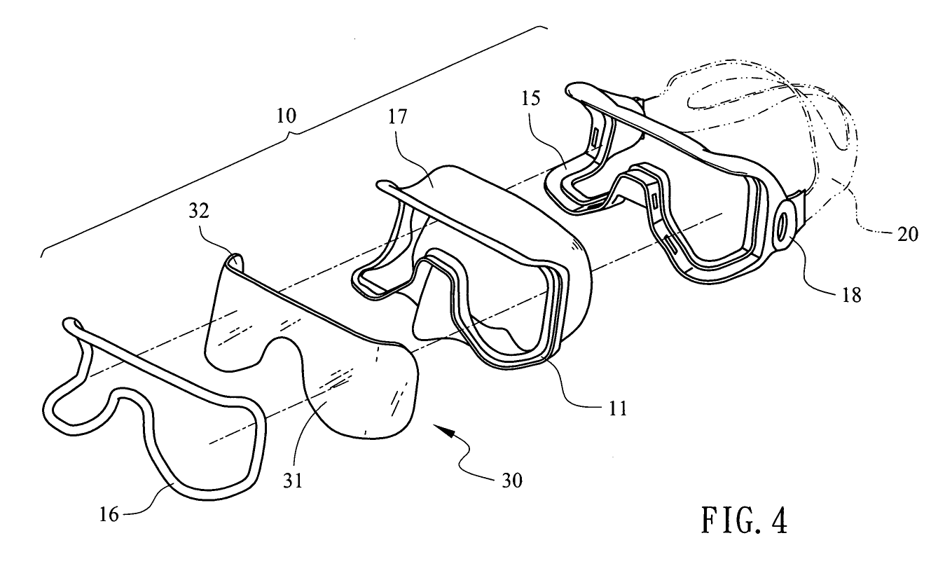

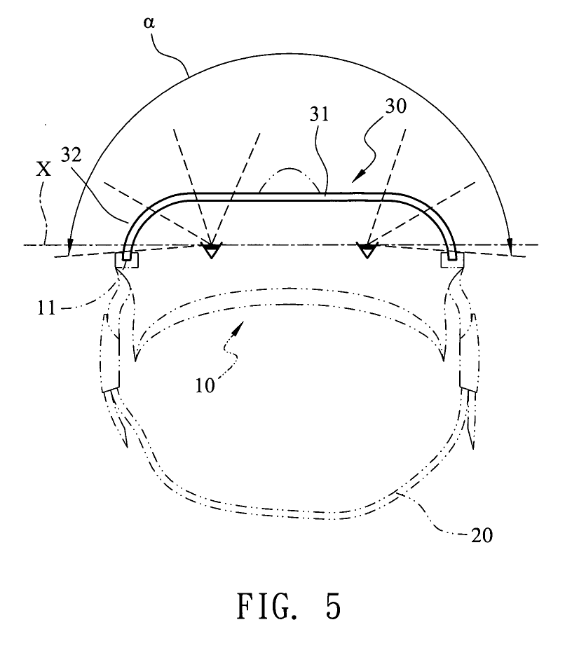

Refer to FIG. 4 for an exploded view and FIG. 5 for a schematic view of a first embodiment of the invention.

The first embodiment mainly includes a mask assembly 10, a strap 20 and a lens 30. The mask assembly 10 includes a main frame 15, a sub frame 16, a skirt 17 and a buckle sets 18. Two ends of the strap 20 are connected to two edges of the mask assembly 10 respectively through the buckle sets 18 to enable the diving mask to be worn and retained on a user's head. The mask assembly 10 has an opening in the center and a narrow groove 11 on an inner wall of the opening to be wedged by the lens 30. The lens 30 is formed integrally with a predetermined curvature, and made from a transparent material such as tempered glass treated by a glass bending process or reinforced optical plastic such as Acrylic (PMMA) and Polycarbonate (PC), etc.

Referring to FIG. 5, the lens 30 has lateral sides formed in a smooth curved surface and extended to the rear side of the left and right eyes of the user. As an illustration, a transverse reference X axis is drawn on the plane where user's eyes are located. The lens 30 has a planar viewing zone 31 and a first vision angle extension zone 32. The first vision angle extension zone 32 is extended in a curved shape towards the rear side of the user's left and right eyes beyond the transverse reference X axis. Hence the total extension angle α of the lens 30 is greater than 110 degrees, or even 180 degrees if desired. Therefore it can provide a horizontal visual angle greater than 110 degrees. Moreover, as the lens 30 is formed integrally, the visual obstacle resulting from the bending angle of the diving mask of a prior art. The user's field of vision on the lateral sides is thus greater.

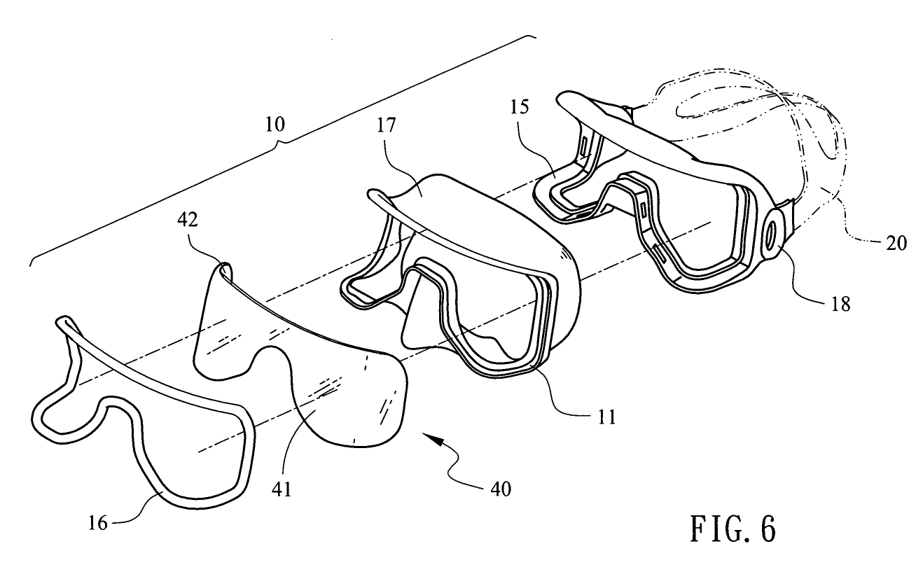

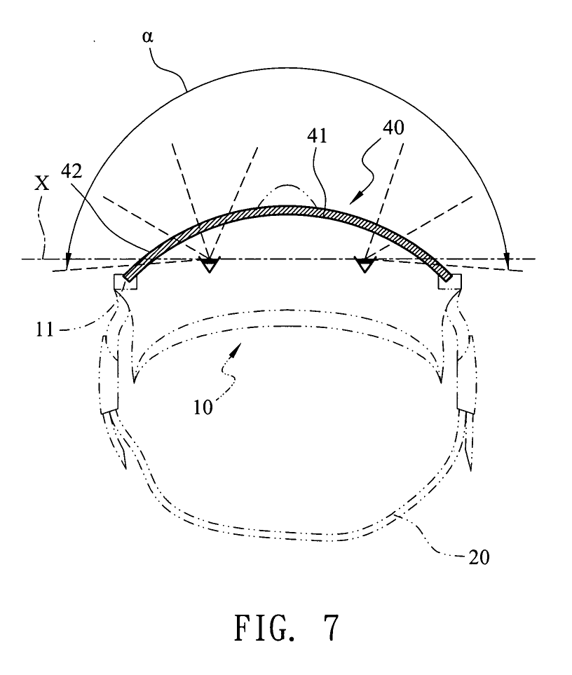

Refer to FIG. 6 for an exploded view and FIG. 7 for a schematic view of a second embodiment of the invention.

The second embodiment mainly includes a mask assembly 10, a strap 20 and a lens 40. The mask assembly 10 includes a main frame 15, a sub frame 16, a skirt 17 and a buckle sets 18. Two ends of the strap 20 are connected to two edges of the mask assembly 10 respectively through the buckle sets 18 to enable the diving mask to be worn and retained on a user's head. The mask assembly 10 has an opening in the center and a narrow groove 11 on an inner wall of the opening to be wedged by the lens 40. The lens 40 is formed with a predetermined curvature with a unitary radius of curvature to form a smooth curve surface, and made from tempered glass treated by a glass bending process or reinforced optical plastic such as Acrylic (PMMA) and Polycarbonate (PC), etc.

Referring to FIG. 7, the lens 40 is smooth curved in a cylindrical type with a vertical reference axis and extended to the rear side of the left and right eyes of the user. As an illustration, a horizontal reference X axis is drawn on the plane where user's eyes are located. The lens 40 has a planar viewing zone 41 and a first vision angle extension zone 42. The first vision angle extension zone 42 is extended towards the rear side of the user's left and right eyes beyond the transverse reference X axis. Hence the total extension angle α of the lens 40 is greater than 110 degrees, or even 180 degrees if desired. Therefore it can provide a horizontal visual angle greater than 110 degrees. Moreover, as the lens 40 is formed with a smooth curved surface having a unitary radius of curvature, the visual obstacle and image distortion resulting from the bending angles or corners of the lens of a prior art, such as U.S. Pat. No. 5,564,132, is eliminated. The user's field-of-view on the lateral sides of the user is thus greater and clearer.

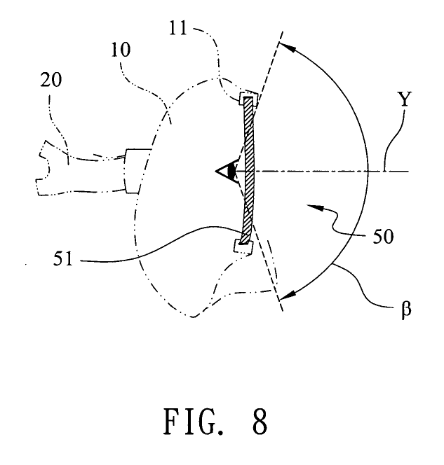

Refer to FIG. 8 for a schematic view of a third embodiment of the invention.

It includes a mask assembly 10, a strap 20 and a lens 50. Two ends of the strap 20 are connected to two edges of the mask assembly 10 to enable the diving mask to be worn and retained on the user's head. The mask assembly 10 has an opening in the center and a narrow groove 11 on an inner wall of the opening to be wedged by the lens 50. The lens 50 is smooth curved in a cylindrical type with a horizontal reference axis witch has a unitary radius curvature, and made from a transparent material such as tempered glass treated by a glass bending process or reinforced optical plastic such as Acrylic (PMMA) and Polycarbonate (PC), etc.

The lens 50 is smooth curved in a cylindrical type with a horizontal reference axis and extended to the upper side and lower side of the user's eyes. As an illustration, a vertical reference Y axis is drawn along the forward and straight visual line of the user's eye. The lens 50 in the third embodiment has a second visual angle extension zone 51 extended in a curved shape towards the upper side and lower side of the user's eyes. Hence the total extension angle β of the lens 50 is greater than 30 degrees, or even proximate to 120 degrees if desired. Therefore it can provide a total field-of-view greater than 30 degrees. The user can easily see the surrounding environment on the upper side and lower side, and the total field-of-view is greater.

It is indeed that the first vision angle extension zone 42 in the second embodiment and the second vision angle extension zone 51 in the third embodiment can be combined to form the lens. Then the visual angles on the upper side, lower side, left side and right side are wider, and a greater field of vision without visual obstacles can be achieved.

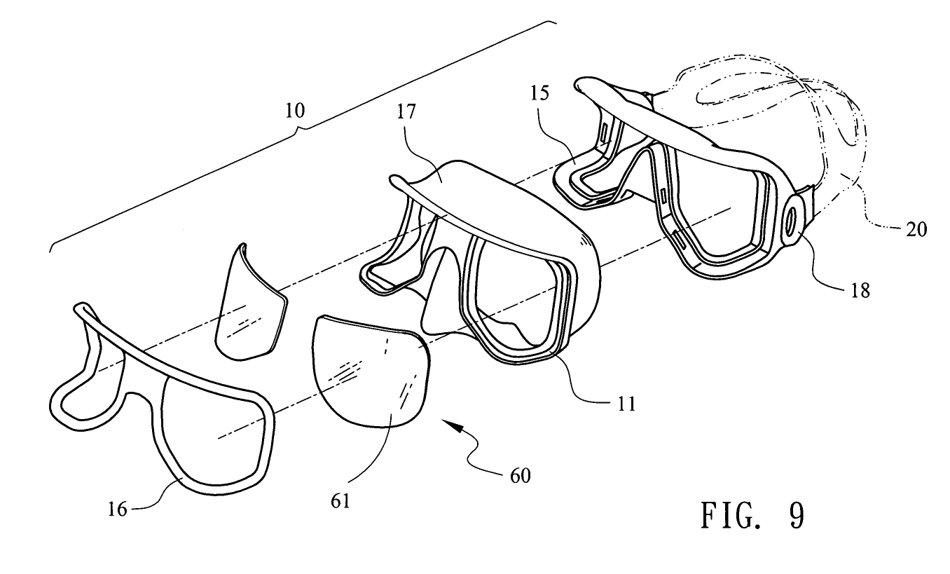

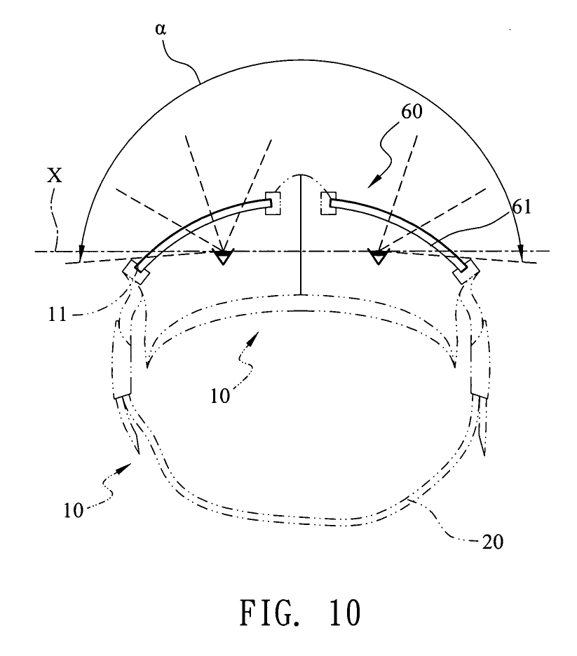

Refer to FIG. 9 for an exploded view and FIG. 10 for a schematic view of a second embodiment of the invention.

It is structured like the second embodiment set forth above. It also has a mask assembly 10 and a strap 20. The difference is that the mask assembly 10 is wedged by two lenses 60 that have a unitary radius of curvature in horizontal axis and a unitary radius of curvature in vertical axis to form a smooth curve surface. Each of the lenses 60 has a curved lateral side 61 that is extended towards the rear side of the user's eye. The two lenses 60 on the left side and right side provide a total field of vision greater than 110 degrees. Hence the visual obstacle and image distortion resulting from the bending angle of the conventional techniques is eliminated. The user's total field of vision is greater.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A diving mask comprising a mask assembly and a strap coupling with the mask assembly, wherein:
the mask assembly is wedged with at least one lens which is formed integrally from a transparent material, the lens having a unitary radius of curvature to form a smooth curve surface which is extended to a rear side of a user's left eye and right eye to provide the user a horizontal visual angle greater than 110 degrees.

2. The diving mask of claim 1, wherein the material for forming the lens is formed from tempered glass.

3. The diving mask of claim 1, wherein the material for forming the lens is formed from reinforced plastic.

4. The diving mask of claim 1, wherein the mask assembly is wedged with two lenses.

5. A diving mask comprising a mask assembly and a strap coupling with the mask assembly, wherein:
the mask assembly is wedged with at least one lens which is formed integrally from a transparent material, the lens having a unitary radius of curvature to form a smooth curve surface which is extended to a upper side and a lower side of a user's eyes to form a vertical visual angle greater than 30 degrees.

6. The diving mask of claim 5, wherein the material for forming the lens is formed from tempered glass.

7. The diving mask of claim 5, wherein the material for forming the lens is formed from reinforced plastic.

8. The diving mask of claim 5, wherein the mask assembly is wedged with two lenses.

9. A diving mask comprising a mask assembly and a strap coupling with the mask assembly, wherein:
the mask assembly is wedged with a lens which is formed integrally from a transparent material, the lens having lateral sides each being bent to form a curved surface which is extended to a rear side of a user's left eye and right eye to provide the user a horizontal visual angle greater than 10 degrees.

10. The diving mask of claim 9, wherein the material for forming the lens is formed from tempered glass.

11. The diving mask of claim 9, wherein the material for forming the lens is formed from reinforced plastic.

12. The diving mask of claim 9, wherein the mask assembly is wedged with two lenses.
